(19) United States
(12) Patent Application Publication
(10) Pub. No.: US 2002/0059326 A1
(43) Pub. Date: May 16, 2002

(54) System, method, and computer program product for management of biological experiment information

(76) Inventors: Derek Bernhart, San Jose, CA (US); Rajindar S. Nijor, Saratoga, CA (US)

Correspondence Address: AFFYMETRIX, INC, ATTN: CHIEF IP COUNSEL, LEGAL DEPT., 3380 CENTRAL EXPRESSWAY, SANTA CLARA, CA, 95051, US

(21) Appl. No.: 09/682,098

(22) Filed: Jul. 19, 2001

Related U.S. Application Data
(60) Provisional application No. 60/220,645, filed on Jul. 25, 2000.
(60) Provisional application No. 60/220,587, filed on Jul. 25, 2000.
(60) Provisional application No. 60/226,999, filed on Aug. 22, 2000.
(60) Provisional application No. 60/273,231, filed on Mar. 2, 2001.

(51) Int. Cl. G06F 12/00

(52) U.S. Cl. 707/203

(57) ABSTRACT

Systems, methods, and computer program products are described, including a method having the steps of providing one or more identifiers, specifying one or more attributes for at least one of the identifiers, generating a data template including the identifier, and receiving by the data template a first value for the identifier in accordance with the one or more attributes. The value is related to use of a probe array. The method may also include storing the first value in a data structure, which may be included in a database. The data template may be an experiment data template or a sample data template. Other steps may include storing image data of a probe array in the data structure; analyzing the image data to generate results data; storing the results data in the data structure; and/or tracking the first value, the image data, and the result data.

### CROSS REFERENCE TO RELATED APPLICATIONS

This application is related to and claims priority from U.S. Provisional Patent Application No. 60/220,645, titled Affymetrix Microarray Suite filed on Jul. 25, 2000; U.S. Provisional Patent Application No. 60/220,587, titled Affymetrix Laboratory Information Management System filed on Jul. 25, 2000; U.S. Provisional Patent Application No. 60/226,999 titled System, Method, and Product for Linked Window Interfaces filed on Aug. 22, 2000; and U.S. Provisional Patent Application No. 60/273,231, titled Software Development Kit for Laboratory Information Management System, filed on Mar. 2, 2001, all of which are hereby incorporated herein by reference for all purposes.

### COPYRIGHT STATEMENT

A portion of the disclosure of this patent document, which includes attached documents specified below, contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND OF INVENTION

Field of the Invention: The present invention relates to computer systems, methods, and products for acquiring and managing experimental data, and particularly data acquired by scanning images of high-density arrays of biological materials.

Related Art: Synthesized probe arrays, such as Affymetrix® GeneChip® arrays, have been used to generate unprecedented amounts of information about biological systems. For example, a commercially available GeneChip® array set from Affymetrix, Inc. of Santa Clara, Calif., is capable of monitoring the expression levels of approximately 6,500 murine genes and expressed sequence tags (EST's). Experimenters can quickly design follow-on experiments with respect to genes, EST's, or other biological materials of interest by, for example, producing in their own laboratories microscope slides containing dense arrays of probes using the Affymetrix® 417™ Arrayer or other spotting devices.

Analysis of data from experiments with synthesized and/or spotted probe arrays may lead to the development of new drugs and new diagnostic tools. In some conventional applications, this analysis begins with the capture of fluorescent signals indicating hybridization of labeled target samples with probes on synthesized or spotted probe arrays. The devices used to capture these signals often are referred to as scanners, an example of which is the Affymetrix® 428™ Scanner from Affymetrix. There is a great demand in the art for methods for organizing, accessing and analyzing the vast amount of information collected by scanning microarrays.

### SUMMARY OF INVENTION

There is a demand among users of probe arrays and others for methods and systems for organizing, accessing and analyzing the vast amount of information collected using nucleic acid probe arrays or using other types of probe arrays. These methods may include the use of software applications and related hardware that implement so-called laboratory information management systems (hereafter, LIMS).

Systems, methods, and computer program products are described herein to address these and other needs. Reference will now be made in detail to illustrative, non-limiting, embodiments. Various other alternatives, modifications and equivalents are possible. As but one of many examples, while certain systems, methods, and computer software products are described using exemplary embodiments for analyzing data from experiments that employ Affymetrix® GeneChip® probe arrays, or spotted arrays (described below), these systems, methods, and products may be applied with respect to data obtained from experiments with other probe arrays and parallel biological assays.

In accordance with some embodiments, a method is described including providing one or more identifiers, specifying one or more attributes for at least one of the identifiers, generating a data template including the identifier, and receiving by the data template a value for the identifier in accordance with the one or more attributes. The value is related to use of a probe array. In this context, the term related to is used broadly and thus, in various implementations, may mean for instance that the value describes an aspect of, or is otherwise based on or related to, a probe array and/or use of a probe array and/or factors involved in preparing, conducting, analyzing, displaying, or evaluating an experiment on a probe array, including preparation of samples, controls, and so on. To provide a few non-limiting examples, the value may be the name of the experimenter, a concentration of the probe or target, a time, a temperature, and many other factors.

In some implementations, the method also includes storing the value in a data structure, which may be included in a database. The identifiers may include experiment identifiers and the data template may include an experiment data template. Also, the identifiers may include sample identifiers and the data template may include a sample data template. The data structure may include an experiment information file.

In various implementations, the method includes storing image data in the data structure, wherein the image data is based, at least in part, on scanning of the probe array. Additional steps in some of these implementations are analyzing the image data to generate results data; storing the results data in the data structure; and/or tracking the first value, the image data, and the result data.

In other embodiments, a method is described that includes receiving from a first user a selection of a first data template having a plurality of identifiers each having one or more attributes; displaying the first data template to the first user in response to the selection; receiving from the first user values for one or more of the identifiers of the first data template in accordance with the attributes of the one or more identifiers; and saving the values in a data structure. In some of these embodiments, the values may be related to (broadly interpreted as noted above) probe arrays.

Also described here are embodiments directed to a computer program product that includes a template generator that generates a data template including one or more identifiers, each having one or more attributes; a value receiver that receives values for the identifiers in accordance with their attributes; and a data storage manager that stores the values in a data structure. In these embodiments, the values are related to (broadly interpreted as noted above) probe arrays.

Further embodiments are directed to a computer implemented system for managing information of probe array experiments. The system includes a computer-readable storage medium; a database; a data template generator coupled to the computer-readable storage medium; and an experiment manager coupled to the computer-readable storage medium and the database. The data template generator generates at least one user-defined data template and stores the user-defined data template on the computer-readable storage medium, each user-defined data template defining attributes of a set of experiment identifiers, a data template being selected from the at least one user-defined data template by a user using the experiment manager, experiment identifiers being inputted using the experiment manager according to the selected data template, the inputted experiment identifiers being stored in the database as an experiment information file.

In yet other embodiments, a computer implemented system for managing information of probe array experiments is described that includes a computer-readable storage medium having at least one default data table stored thereon; a database; a data template generator coupled to the computer-readable storage medium; and an experiment manager coupled to the computer-readable storage medium and the database. The data template generator generates at least one user-defined data template and stores the user-defined data template on the computer-readable storage medium, each user-defined data template defining the attributes of a set of experiment identifiers, a data template being selected from the group consisting of the default data table and the user-defined data template by a user using the experiment manager, experiment identifiers being inputted using the experiment manager according to the selected data template, the inputted experiment identifiers being stored in the database as an experiment information file.

The above implementations are not necessarily inclusive or exclusive of each other and may be combined in any manner that is non-conflicting and otherwise possible, whether they be presented in association with a same, or a different, aspect or implementation. The description of one implementation is not intended to be limiting with respect to other implementations. Also, any one or more function, step, operation, or technique described elsewhere in this specification may, in alternative implementations, be combined with any one or more function, step, operation, or technique described in the summary. Thus, the above implementations are illustrative rather than limiting.

### BRIEF DESCRIPTION OF DRAWINGS

The above and further advantages will be more clearly appreciated from the following detailed description when taken in conjunction with the accompanying drawings. In the drawings, like reference numerals indicate like structures or method steps and the leftmost digit of a reference numeral indicates the number of the figure in which the referenced element first appears (for example, the element 120 appears first in FIG. 1).

FIG. 1 is a simplified flowchart of an illustrative process for carrying out a research project; FIG. 2 is a simplified graphical representation of data flow in an illustrative probe array assay; FIG. 3 is a functional block diagram of illustrative computer program products suitable for managing experimental information in accordance with illustrative embodiments of the present invention; FIGS. 4A-F are graphical representations of illustrative user interfaces for providing experiment templates employing the computer program products of FIG. 3; FIG. 5 is a flow chart of one embodiment of a method for providing experiment information; and FIG. 6 is a graphical representation of an illustrative user interface for providing experiment information.

### DETAILED DESCRIPTION

The present invention may be embodied as a method, data processing and/or analysis system, software program product or products, or any combination thereof. _Toc472387898Embodiments_Toc472387898 described herein may refer to commercially available probe arrays, instruments, and/or software products, but it will be understood that such references are illustrative only. For example, in the following description references may be made to the Affymetrix® Microarray Suite 4.0 and Affymetrix® Laboratory Information Management System 2.0 as examples of commercially available software that may be used to implement aspects of illustrative embodiments. The present invention, however, is not limited to these products or other software.

Various techniques and technologies may be used for depositing or synthesizing dense arrays of biological materials on a substrate or support. For example, Affymetrix GeneChip® arrays are synthesized in accordance with techniques sometimes referred to as VLSIPS™ (Very Large Scale Immobilized Polymer Synthesis) technology. An array developed with this technology, and others that are now available and may in the future be developed for synthesizing arrays of biological materials, may hereafter be referred to for convenience as an in situ synthesized array.

Some aspects of VLSIPS™ technology are described in the following U.S. Patents: U.S. Pat. No. 5,143,854 to Pirrung, et al.; U.S. Pat. Nos. 5,445,934; 5,744,305 to Fodor, et al.; U.S. Pat. No. 5,831,070 to Pease, et al.; U.S. Pat. No. 5,837,832 to Chee, et al.; U.S. Pat. No. 6,022,963 to McGall, et al.; and U.S. Pat. No. 6,083,697 to Beecher, et al. Each of these patents is hereby incorporated by reference in its entirety. The probes of these arrays consist of oligonucleotides, which are synthesized by methods that include the steps of activating regions of a substrate and then contacting the substrate with a selected monomer solution. The regions are activated with a light source shown through a mask in a manner similar to photolithography techniques used in the fabrication of integrated circuits. Other regions of the substrate remain inactive because the mask blocks them from illumination. By repeatedly activating different sets of regions and contacting different monomer solutions with the substrate, a diverse array of polymers is produced on the substrate. Various other steps, such as washing unreacted monomer solution from the substrate, are employed in various implementations of these methods.

These probes typically are used in conjunction with tagged biological samples such as proteins, genes or EST's, other DNA sequences, or other biological elements. These samples, referred to herein as targets, are processed so that they are spatially associated with certain probes in the probe array. For example, one or more chemically tagged biological samples, i.e., the targets, are distributed over the probe array. Some targets hybridize with at least partially complementary probes and remain at the probe locations, while non-hybridized targets are washed away. These hybridized targets, with their tags or labels, are thus spatially associated with the targets' complementary probes. The hybridized probe and target may sometimes be referred to as a probe-target pair. Detection of these pairs can serve a variety of purposes, such as to determine whether a target nucleic acid has a nucleotide sequence identical to or different from a specific reference sequence. See, for example, U.S. Pat. No. 5,837,832, referred to and incorporated above. Other uses include gene expression monitoring and evaluation (see, e.g., U.S. Pat. No. 5,800,992 to Fodor, et al.; U.S. Pat. No. 6,040,138 to Lockhart, et al.; and International App. No. PCT/US98/15151, published as WO99/05323, to Balaban, et al.), genotyping (U.S. Pat. No. 5,856,092 to Dale, et al.), or other detection of nucleic acids. The '992, '138, and '092 patents, and publication WO99/05323, are incorporated by reference herein in their entirety for all purposes.

Other techniques exist for depositing probes on a substrate or support. For example, spotted arrays are commercially fabricated, typically on microscope slides. These arrays typically consist of liquid spots containing biological material of potentially varying compositions and concentrations. For instance, a spot in the array may include a few strands of short oligonucleotides in a water solution, or it may include a high concentration of long strands of complex proteins. The Affymetrix® 417™ Arrayer is a device that deposits a densely packed array of biological material on a microscope slide in accordance with these techniques. Preferred aspects of this, and other, spot arrayers are described in U.S. Pat. Nos. 6,040,193 and 6,136,269, and in PCT Application No. PCT/US99/00730 (International Publication Number WO 99/36760), all of which are hereby incorporated by reference in their entireties for all purposes. Other techniques for generating spotted arrays also exist. The U.S. Pat. No. 6,040,193, and U.S. Pat. No. 5,885,837 to Winkler, also describe the use of micro-channels or micro-grooves on a substrate, or on a block placed on a substrate, to synthesize arrays of biological materials. These patents further describe separating reactive regions of a substrate from each other by inert regions and spotting on the reactive regions. The '193 and '837 patents are hereby incorporated by reference in their entireties. Another technique is based on ejecting jets of biological material to form a spotted array. Other implementations of the jetting technique may use devices such as syringes or piezo electric pumps to propel the biological material. Various other techniques exist for synthesizing, depositing, or positioning biological material onto or within a substrate.

To ensure proper interpretation of the term probe as used herein, it is noted that contradictory conventions exist in the relevant literature. The word probe is used in some contexts to refer not to the biological material that is synthesized on a substrate or deposited on a slide, as described above, but to what has been referred to herein as the target. To avoid confusion, the term probe is used herein to refer to probes such as those synthesized according to the VLSIPS™ technology; the biological materials deposited so as to create spotted arrays; and materials synthesized, deposited, or positioned to form arrays according to other current or future technologies. Thus, microarrays formed in accordance with any of these technologies may be referred to generally and collectively hereafter for convenience as probe arrays. Moreover, the term probe is not limited to probes immobilized in array format. Rather, the functions and methods described herein may also be employed with respect to other parallel assay devices. For example, these functions and methods may be applied with respect to probe-set identifiers that identify probes immobilized on or in beads, optical fibers, or other substrates or media.

Various computer-aided techniques for monitoring gene expression using probe arrays have been developed as disclosed in EP Pub No. 0848067 and PCT Pub No. WO97/10365, both of which are herein incorporated by reference in their entireties for all purposes. Many disease states are characterized by differences in the expression levels of various genes either through changes in the copy number of the genetic DNA or through changes in levels of transcription (e.g., through control of initiation, provision of RNA precursors, RNA processing, etc.) of particular genes. For example, losses and gains of genetic material play an important role in malignant transformation and progression. Furthermore, changes in the expression (transcription) levels of particular genes (e.g., oncogenes or tumor suppressors), serve as signposts for the presence and progression of various cancers.

These computer-aided techniques for variant detection and expression monitoring typically are themselves multi-stage processes including, e.g., stages of selecting sequences, overall chip layout, mask design, probe synthesis, sample preparation, application of samples to chips, scanning of samples, and analysis of scanning results. For each stage, there typically is associated control information that determines in some way how the processing of the stage is performed. For many stages, result information is also generated. Moreover, processing at one stage may depend on control information or result information from a previous stage. In view of the complexity and scope of these operations, there is a need to organize all of the relevant information for convenient access and retrieval.

Many of the contemplated applications of probe arrays involve performing all of the various stages on a very large scale. For example, consider surveying a large population of human subjects to discover oncogenes and tumor suppressor genes relevant to a particular form of cancer. Large numbers of samples must be collected and processed. Information about the sample donors and sample preparation condition should be maintained to facilitate later analysis. The probe array chips will have associated layout information. Each chip will be processed with samples and scanned individually. Each chip will thus have its own scanning results. Finally, the scanning results will be interpreted and analyzed for many subjects in an effort to identify the oncogenes and tumor suppressors. The quantity of information to store and correlate is vast. Compounding the information management problem, equipment and other laboratory resources may be shared with other projects. A single laboratory may service many clients, each client in turn requesting completion of multiple projects. Therefore, there is a great demand in the art for methods and systems for organizing, accessing and analyzing the vast amount of information generated and collected using nucleic probe arrays, as well as other information related to each probe array assay.

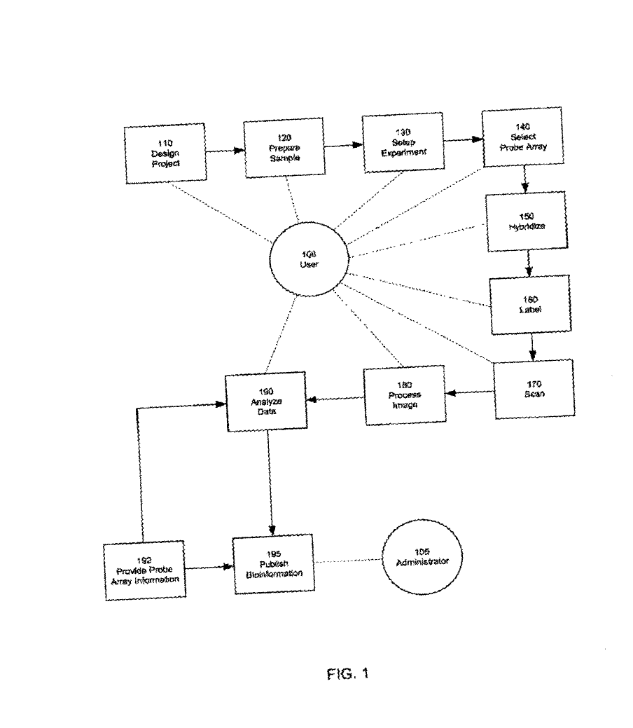

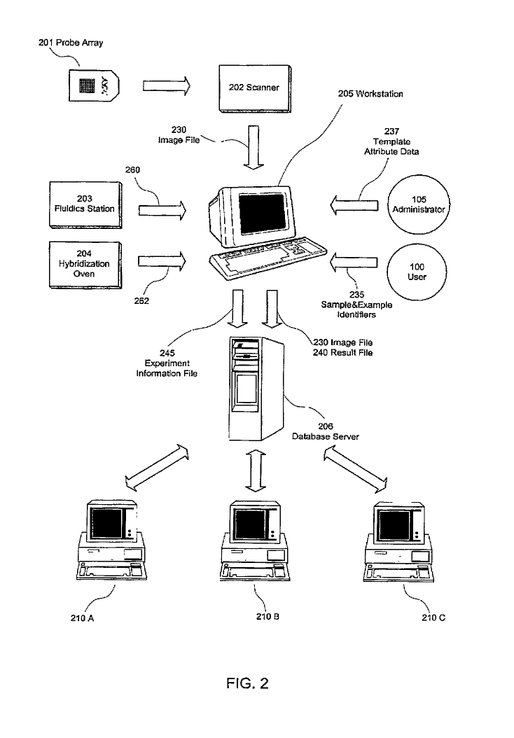

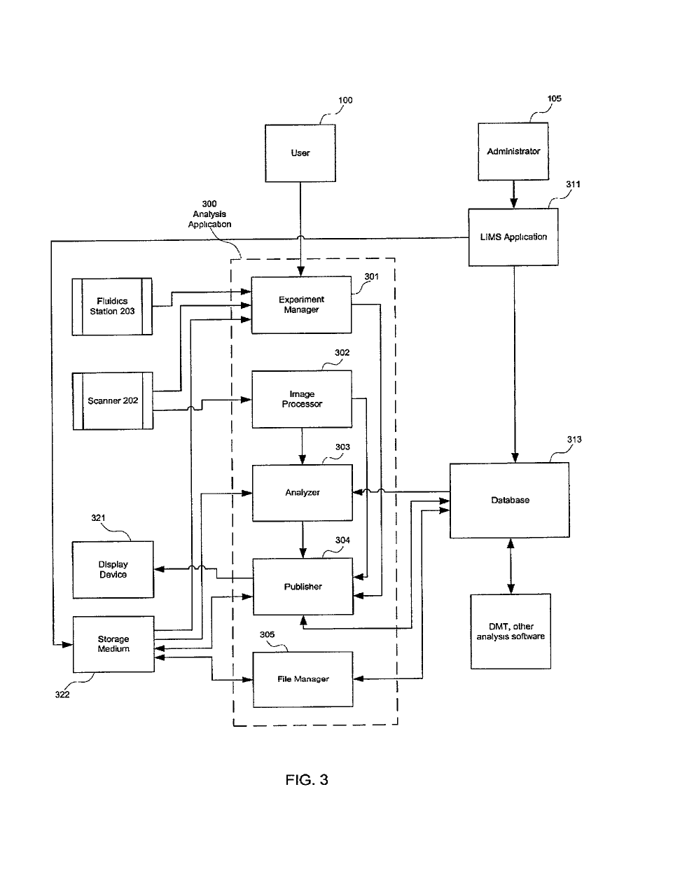

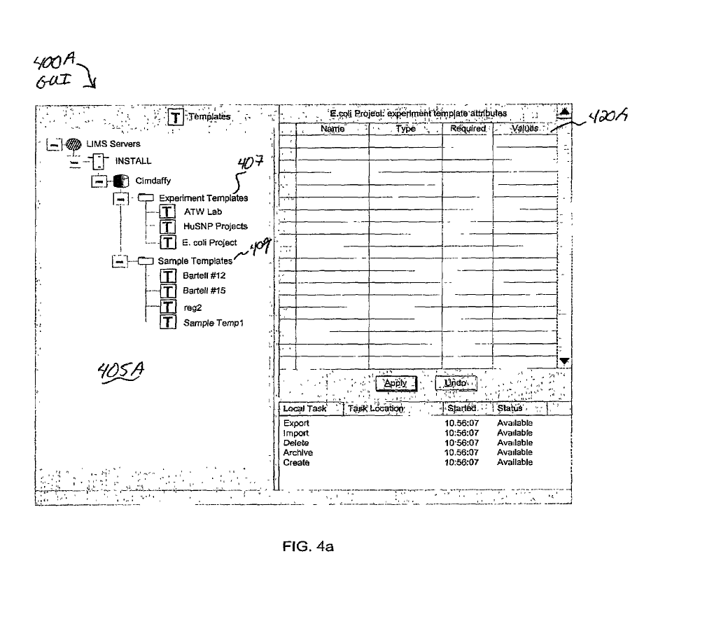

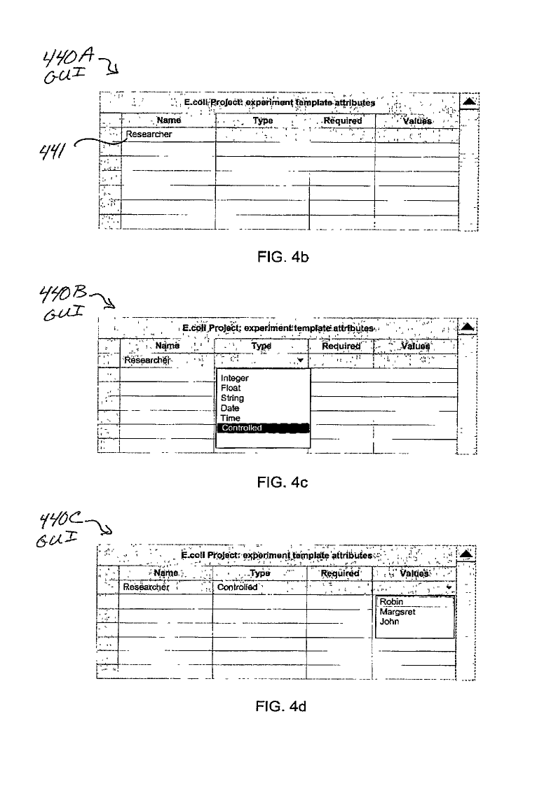

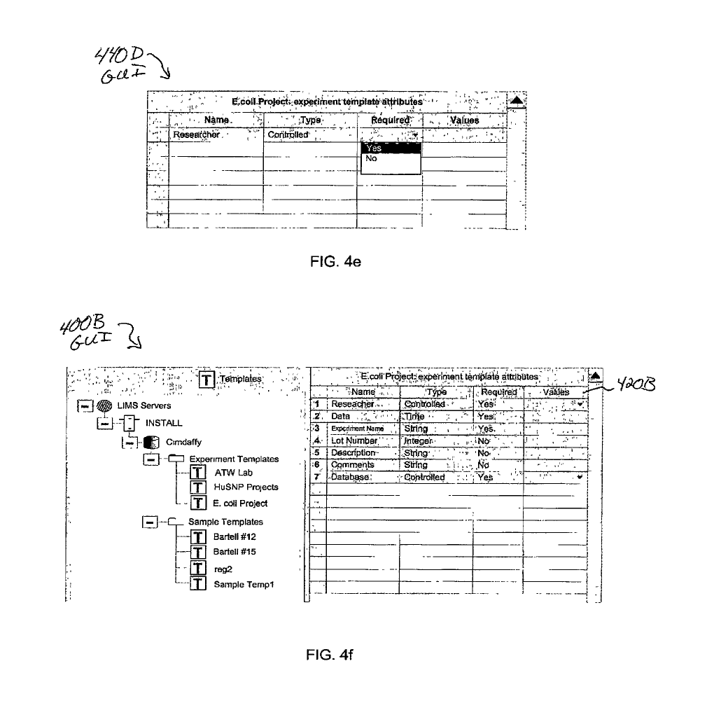

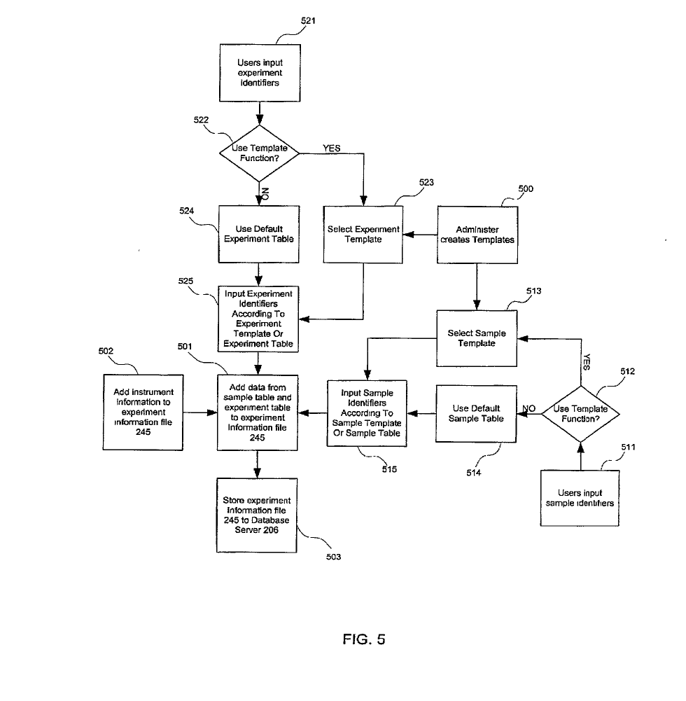

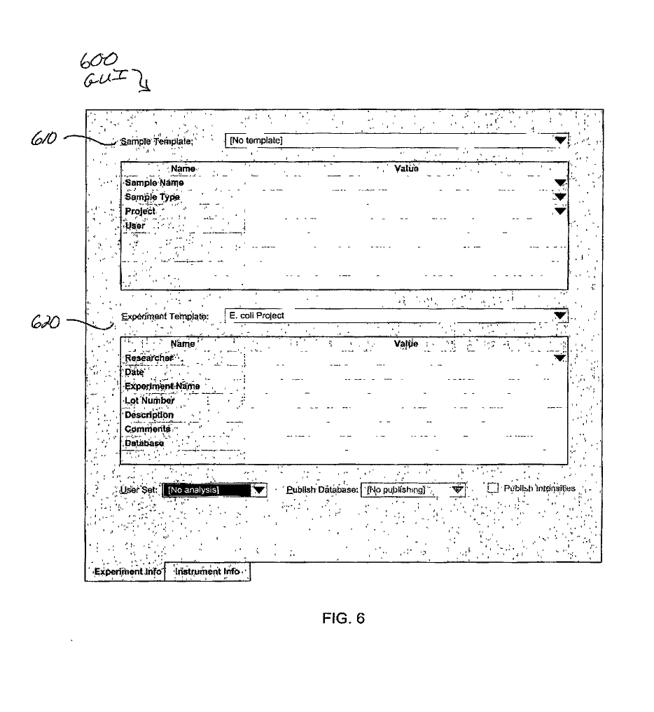

As noted, probe arrays have been developed to acquire biological information. FIG. 1 provides an overview flow chart of a typical procedure for a laboratory probe array assay. In step 110, user 100 designs a research project. The project typically involves different samples and varied experiments. Plural research teams and researchers may corporate on one research project. Part of these samples and experiments are assigned to one user, referred to hereafter as user 100 (who illustratively is assumed to have contributed to the development of the research project, as shown in FIG. 1). (The illustrative activities parenthetically outlined are non-limiting examples of preferred embodiments within each step.) User 100 typically prepares a sample (step 120; e.g., feeds mice with drugs for a specific period, sacrifices a mouse, acquires the liver, and homogenizes the liver), sets up an experiment (step 130; e.g., makes further sample treatment, determines fluidics condition, and prepares reagents), and selects an appropriate probe array to be used in an assay (step 140). The prepared sample is than hybridized with the probe array, preferably in a hybridization oven (step 150) to allow binding of a target nucleic acid with a probe on the chip. The target-probe nucleic acid complex is fluorescently labeled (or otherwise labeled in other implementations; see step 160). Other processing, such as washing, may also occur. The probe array is introduced into a scanner (such as scanner 202 noted below) to generate an image file indicating the locations where the labeled nucleic acids bound to the chip (see image processing step 180). As is well known in the art, scanners image the targets by detecting fluorescent or other emissions from the labels, or by detecting transmitted, reflected, or scattered radiation. These processes are generally and collectively referred to hereafter for convenience simply as involving the detection of emissions. Various detection schemes are employed depending on the type of emissions and other factors. A typical scheme employs optical and other elements to provide excitation light and to selectively collect the emissions. Also generally included are various light-detector systems employing photodiodes, charge-coupled devices, photomultiplier tubes, or similar devices to register the collected emissions. For example, a scanning system for use with a fluorescent label is described in U.S. Pat. No. 5,143,854, incorporated by reference above. Other scanners or scanning systems are described in U.S. Pat. Nos. 5,578,832; 5,631,734; 5,834,758; 5,936,324; 5,981,956; 6,025,601; 6,141,096; 6,185,030; and 6,201,639, and in PCT Application PCT/US99/06097 (published as WO99/47964), each of which is hereby incorporated by reference in its entirety for all purposes.

Based upon the identities of the probes at these locations, it becomes possible to extract information such as the monomer sequence of DNA and expression level of a specific target gene (see data analysis step 190). Other information typically is provided to facilitate or enable analysis, such as data describing the probes used in the probe arrays (see step 192). The analyzed result may be published, i.e., formatted in a standardized way, to a bioinformatics database. In addition to user 100, an administrator 105 may manage the bioinformatics database.

FIG. 2 is a graphical representation of illustrative data flows that may occur during various stages of probe array assays and in analyses or other uses of data derived from the assays. Scanner 202 scans probe array 201 (which, as noted, may be any type of synthesized, spotted, or other array or parallel biological assay) and generates image file 230. File 230 includes data indicating the locations of labeled probe-target pairs. Image file 230, together with data 260 describing various aspects of the operation of fluidics station 203 and data 262 describing various aspects of hybridization oven 204, are inputted into workstation 205.

Workstation 205 may be a personal computer, a workstation, a server, or any other type of computing platform now available or that may be developed in the future. As is well known to those of ordinary skill in the relevant art, computer workstation 205 typically includes known components such as processor (e.g., CPU), operating system, system memory, memory storage devices, graphical user interface (GUI) controller, and input-output controllers, and other components, some of which typically communicate in accordance with known techniques such as via system bus. It is illustratively assumed for clarity and convenience that both user 100 and administrator 105 employ workstation 205. However, as will be evident to those of ordinary skill in the art, user 100 and/or administrator 105 could alternatively use one of data analysis workstations 210A-C (generally and collectively referred to hereafter as workstations 210).

In the illustrated implementation, certain types of computer programs described below in relation to FIG. 3 are assumed to be executing on workstation 205. These programs, commercial examples of which include Affymetrix® Microarray Suite, Affymetrix® Jaguar™ Software, and aspects of Affymetrix® LIMS, all available from Affymetrix, Inc., typically provide image analysis and data analysis functions to provide what is referred to for convenience herein as results files 240 (containing what may hereafter be referred to as results data). These computer programs are hereafter referred to for convenience as analysis applications, although it will be understood that they typically also perform various functions in addition to analysis, such as control of scanner 202, station 203, oven 204, or other functions. It also will be understood that the term file is used broadly herein to refer to any of a variety of techniques and forms for storing, transferring, and using data in a computer environment. These files may be stored locally, remotely (e.g., over a network), and/or distributed locally or remotely. In addition, user 100 may input sample and experiment identifiers 235, described below, into workstation 205 for use by the analysis applications. Also, administrator 105 may input data representing attributes of experiment templates or sample templates, shown in FIG. 2 as template attribute data 237.

Image file 230 and result files 240 in the illustrated implementation are stored on database server 206. Commercial software such as aspects of Affymetrix® LIMS and other laboratory information software may be executing on server 206. Experiment information files 245, described below, are also stored on database server 206 in this implementation. User 100, or other authorized users working on the same research project, may access database server 206 through data analysis workstations 210 in order to further analyze aspects of the data stored on server 206. For example, using commercial data mining software, such as Affymetrix® Data Mining Tool as one example, users may employ one or more of workstations 210 to mine data stored on server 206. See U.S. Pat. No. 6,185,561, which is hereby incorporated by reference herein in its entirety for all purposes.

It is advantageous that information about the sample and experiment, e.g., as contained in experiment information files 245, as well of course as image files 230 and results files 240, be accessible to authorized users employing workstations 210. This access may be especially useful for researchers or laboratories working collaboratively on a project. For example, when studying new anti-cancer drugs, the name of drug, dosage used, the period of treatment, the organ or tissue where the sample is taken from, the race and gender of patient, and other types of data that may be represented in experiment information files 245, may all be important in conjunction with consideration of image files 230 or results files 240. Traditionally, such information has been recorded in laboratory notes or in an isolated database, and may be difficult or inconvenient to share with others. Associating important sample and experiment identifiers file data with image data and analyzed results data is an important contribution in solving this problem.

FIG. 3 is a functional block diagram of illustrative analysis application 300 and illustrative LIMS application 311. As noted, aspects of, or all of, either of these applications may in various implementations be executed on server 206, workstation 205, and/or workstations 210, although the principal database functions of LIMS application 311 typically are executed on server 206. Also, in the illustrated implementations, analysis application 300 may be executed either in cooperation with LIMS application 311, or as a stand alone application. FIG. 3 shows the data flow among analysis application 300, LIMS application 311, and peripheral instruments and other devices when analysis application 300 is run in cooperate with LIMS application 311.

As now described in relation to FIGS. 4A-F, administrator 105 in the illustrated implementations uses LIMS application 311 to generate template attribute data 237 that are used by application 300 to generate experiment templates and/or sample templates according to specific requirements of different projects or experiments. These functions of application 311 may, in some implementations, be included in application 300. Thus, for clarity, one or both of application 311 and/or application 300 may hereafter be referred to singly or collectively as a template generator. In order to have the intended affect, administrator 105 typically performs these operations before user 100 conducts the projects or experiments. In one embodiment, these generated templates, examples of which are shown graphically in FIGS. 4A-F, are stored on storage medium 322, which conveniently may be located in workstation 205 but also may be located in server 206 or another computer platform in alternative implementations. The operations of components of application 300 are described below in relation to the graphical user interfaces represented in FIGS. 4A-F.

FIG. 4A shows an illustrative graphical user interface (GUI) 400A. GUI 400A in this implementation is a dialog box by which administrator 105 generates a new experiment template named E. coli Projects using aspects of LIMS application 311. GUI 400A includes page 405A on the left and pane 420A on the upper right in this example. Pane 405A includes a tree data structure that lists available experiment and sample templates. Administrator 105 may select an existing template to edit from the pane 405A, or create a new template. Upon selecting a template, or indicating in accordance with conventional techniques that a new template should be created, administrator 105 uses pane 420A to define template attribute data 237, e.g., attributes of names, types and values for the experiment or sample template.

As illustratively shown in GUI 440A of FIG. 4B, administrator 105 inputs the name (i.e., attribute value) of a first experiment identifier in graphical element 441. This attribute value is Researcher in this example. The data type of each identifier may be defined by selecting one of one or more choices from the drop-down list of Type column, as shown in FIG. 4C. In this illustrative example, there are six different types of data: integer number type, floating point data type, character string type, date type, time type, and controlled type. For controlled type data, acceptable values as input by user 100 are limited to the items listed in a drop-down list of Value column defined via GUI's 440A-D (GUI's 440) by administrator 105. As seen in FIG. 4D, only three researchers are listed in this experiment template. Thus, there are only three authorized researchers for this specific experiment. This feature is advantageous in that it prevents access by unauthorized users, e.g., users not recognized as authorized by administrator 105. Moreover, some experiments involve an evaluation of new drugs with complex and possibly unfamiliar scientific names. Use of the controlled type attribute, with a predefined drop-down list, is useful in preventing user 100 from misspelling a name or other term and thus making more difficult the task of retrieving and correlating data. Also, as shown in FIG. 4E, administrator 105 may set a cell to be required or not, depending on the importance of that identifier. If a cell is required, then user 100 may not leave it empty when inputting experimental information. GUI 400B of FIG. 4F corresponds to GUI 400A after administrator 105 has completed the entry of template attributes. Administrator 105 signifies the completion of this task in accordance with any of a variety of conventional techniques, and template attribute data 237 corresponding to the entered data is stored in storage medium 322.

It will be understood that the attributes described in FIGS. 4A-F are illustrative only, and that administrator 105 may specify in experiment templates many other attributes relating to experiments and many other attributes relating to samples (i.e., to be used as targets in probe array assays) in sample templates. For example, other experiment or sample attributes include factors such as concentration of the probe and target, time, temperature, cation concentration, valency and character, pH, dielectric and chaotropic media, and density spacing of the probe molecules synthesized on the surface.

FIG. 5 is a flow chart that shows an illustrative example of steps by which administrator 105 may input template attribute data 237, user 100 may access the resulting templates, and the resulting information, together with data from image files 230 and/or results files 240, may be used by analysis application 300. In this example, administrator 105 uses LIMS application 311 to generate experiment templates and sample templates (step 500) by providing template attribute data 237 via, for example, GUI's 400 and 440. User 100 inputs sample data at the beginning of a probe array assay (step 511). User 100 may select whether to use a sample template or not (step 512). If specific sample factors are important for a research project, user 100 may wish to choose one sample template created specifically for that research project when inputting sample identifiers (step 513). The inputted sample identifiers then become a portion of experiment information file 245 (see step 501). Use of a sample template typically is advantageous to avoid repeated entry of the same sample information for multiple experiments using the same sample. User 100 may also choose not to use a sample template generated by administrator 105 for a specific sample, and instead input sample identifiers according to a default sample table (step 514). In this case too, the inputted sample identifiers are included as data in experiment information file 245 (step 501).

User 100 also inputs experiment identifiers at the beginning of a probe array assay (step 521). User 100 decides whether to use an experiment template or not (step 522). If specific experimental factors are important for a research project, user 100 may select an experiment template generated by administrator 105 specifically for that research project (step 523). The inputted experiment identifiers then are included as data in experiment information file 245 (step 501). User 100 may also choose not to use experiment template and instead provide experiment identifiers according to a default experiment table (step 524). In this case as well, the inputted experiment identifiers then are entered as data in experiment information file 245 (step 501). In addition to the experimental and sample data, instrument information 502 may also be introduced into experiment information file 245 (steps 502 and 501). Experiment information file 245 may be stored in an appropriate database, as represented in this implementation by database 313, which may be located for example in server 206 for central access. Practically, an administrator may also be a user and thus references to a user, such as user 100, may also include administrator 105 in some implementations.

FIG. 6 is a graphical representation of an illustrative interface by which user 100 inputs data into experiment information file 245 using, for example, analysis application 300. That is, application 300 may provide conventional support for generating GUI's, receiving user data from the GUI's, processing the data, storing the data in memory, and so on. In the example of GUI 600 shown in FIG. 6, a default sample table (pane 610) and a default experiment table (pane 620) are displayed as default dialog boxes. User 100 may either input experiment information according to the default sample/experiment tables, or select sample template and/or experiment template from drop-down lists or in accordance with other conventional techniques.

Referring back to FIG. 3, analysis application 300 includes in this example five components: experiment manager 301, image processor 302, analyzer 303, publisher 304, and file manager 305. User 100 inputs sample and experiment identifiers into experiment manager 301 according to a default table or a data template stored on storage medium 322. User 330 may set up fluidics protocol and scanning parameters using analysis application 300 so that fluidics station 203 and scanner 202 may be operated under the control of analysis application 300. Experiment manager 301 captures information about the fluidics protocol and scanning parameters after probe array 201 is processed in fluidics station 203 and is scanned in scanner 202. This information is processed and sent to publisher 304 as an experiment information file 245 in this example. Experiment information file 245 may be stored in a database 313 for further analysis using other analysis software, such as Affymetrix® Data Mining Tool. Other authorized cooperating researchers may also access file 245 from database 313. Publisher 304, under control of user 100, may also display information from experiment information file 245 on display device 321.

Image file 230 is generated by scanner 202 and sent to image processor 302 after scanner 202 scans probe array 201. Image processor 302 in some implementations superimposes a grid on the scan image for purposes of alignment. An alignment algorithm aligns the grid so that it delineates the probe cells. Aspects of these and related operations are described in greater detail in a U.S. Patent Application entitled System, Method, and Computer Software Product for Grid Alignment of Multiple Scanned Images, attorney docket number 3351.3, filed on Jul. 17, 2001, which is hereby incorporated herein by reference in its entirety for all purposes. User 330 may also manually adjust the grid in case of grid misalignment. Intensity values for each probe cell are than calculated by image processor 302 according to cell analysis algorithms and are stored as a cell intensity file. In an illustrative implementation, this cell intensity file is sent to publisher 304 and is stored on the same storage medium where the experiment information file is stored. Other authorized users may also read the file if it is stored on database 313.

The cell intensity file of the illustrated implementation may be sent to analyzer 303 for analysis. For example, when an Affymetrix® Hu6800 Array is used, analyzer 303 may provide gene expression analysis based on the cell intensity file and the probe array information of the Hu6800 Array. As another example, if an experiment is conducted using an Affymetrix® HuSNP™ Array as the probe array, a genotype analysis may be carried out by analyzer 303. Analyzer 303 acquires probe array information from an electronically stored database, which may be saved on storage medium 322, database 313, or any other storage medium. Typically, the probe array information file provides information about the probe array design characteristics, scanning parameters, and default analysis parameters. The analysis output file may be provided to publisher 304 and saved on the same storage medium where the experiment information file is stored. Of course, the user may send the analysis output file to any other preferred destination. Publisher 304 may also retrieve information from database 313 or storage medium 322 and display it on display device 321, which may be, for example, a computer monitor or printer.

File manager 305 is designed to manage files derived from experiments. Through file manager 305, user 100 may trace and find files for a specific project, sample, or experiment. In one embodiment of the invention, the experiment information file, image data file, cell intensity file, and analysis output file of one experiment are saved on the same database using a common file name that is the same as the experiment name specified during inputting experiment information. User 100 may readily distinguish among different types of files from their file extensions, such as *.exp (experiment information files), *.dat (image data files), *.cel (cell intensity files), and *.chp or *.spt (chip or spot analysis output files). Further details regarding cell files, chip files, and spot files are provided in U.S. Provisional Patent Application Nos. 60/220,645, 60/220,587, and 60/226,999, incorporated by reference above. File manager 305 may display the files on display device 321 according to the sample history. When selecting sample history file view, file manager 305 may display all files derived from a particular sample. If a sample history process view is selected, file manager 305 may display the sequential stages of sample registration, experiment setup, hybridization, scan, grid alignment, cell intensity analysis, and probe array analysis. File manager 305 may also show all complete stages or pending stages for a particular sample, or help user 100 monitor the experiment work flow. Accordingly, user 100 may easily manage the complicated experiment information of different research projects and experiments.

As noted, analysis application 300 may also be run as a stand-alone application. In this mode, user 330 inputs sample and experiment information into experiment manager 301 according to a default table. Experiment manager 301 captures information about the fluidics protocol and scanning parameters automatically after the probe array 201 is processed in the fluidics station 203 and is scanned in the scanner 202. User 330 can set up fluidics protocol and scanning parameters using analysis application 300, then fluidics station 203 and scanner 202 are operated under the control of analysis application 300. The experimental information is saved on storage medium 322 as an experiment information file. Image data file of a fluorescence-labeled nucleic acid-probe array, for example, may be sent from scanner 202 to image processor 302 after probe array 201 is scanned in scanner 202. Image processor 302 adjusts grid alignment to superimpose a grid on the scan image. The alignment algorithm aligns the grid so that it delineates the probe cells. User 330 may also adjust the grid manually in case of grid misalignment. Intensity values for each probe cell are than calculated by image processor 302 according to the cell analysis algorithm. The data are stored as a cell intensity file on the storage medium 322.

Although the present invention is described using specific examples and embodiments, it should be understood that the examples and embodiments described herein are for illustrative purposes only and that various modifications or changes in light thereof will be suggested to persons skilled in the art and are to be included within the spirit and purview of this application and scope of the appended claims. For example, the probes needs not be nucleic acid probes. Files, tables, data structures, or other element or technique for storing or saving information (generally and collectively referred to herein for convenience as data structures) may be deleted, contents of multiple data structures may be consolidated, or contents of one or more data structures may be distributed to improve query speeds and/or to aid system maintenance. Also, the database architecture and data models described herein are not limited to biological applications but may be used in any application, and the storage medium can be electrical, optical, magnetic, magneto-optical, and so on. Software applications referred to herein may be implemented using any of a variety of programming language such as, without limitation, Microsoft® Visual C++, Java, C++, Visual Basic, any other high-level or low-level programming language, or any combination thereof.

1. A method comprising the steps of:
(a) providing one or more identifiers;
(b) specifying one or more attributes for at least one of the identifiers;
(c) generating a data template including the identifier; and
(d) receiving by the data template a value for the identifier in accordance
with the one or more attributes; wherein the value is related to use of a probe array.

2. The method of claim 1, further comprising the step of:
(e) storing the value in a data structure.

3. The method of claim 2, wherein:
the data structure is included in a database.

4. The method of claim 1, wherein:
the identifiers include experiment identifiers and the data template includes an experiment data template.

5. The method of claim 1, wherein:
the identifiers include sample identifiers and the data template includes a sample data template.

6. The method of claim 1, wherein:
the data structure includes an experiment information file.

7. The method of claim 1, further comprising the step of:
(e) displaying the data template to a first user.

8. The method of claim 7, wherein:
the value is provided by the first user responsive to displaying the data template.

9. The method of claim 7, wherein:
the value is provided by the first user in accordance with a first type attribute.

10. The method of claim 9, wherein:
the first type attribute is a date attribute, time attribute, integer attribute, floating point data attribute, character string attribute, required attribute, or controlled attribute.

11. The method of claim 10, wherein:
the value is provided by the first user in accordance with a required attribute.

12. The method of claim 11, wherein:
the required attribute specifies that the value is either required or not required to be received.

13. The method of claim 10, wherein:
the value is provided by the user in accordance with a controlled attribute.

14. The method of claim 13, wherein:
the controlled attribute specifies that the value is to be one or more of a plurality of user-specified values specified by a second user.

15. The method of claim 14, wherein:
the first and second users are different users.

16. The method of claim 2, further including the step of:
(f) storing instrument information for at least one instrument in the data structure, wherein the instrument is included in an experiment related to the probe array.

17. The method of claim 2, further including the step of:
(f) storing image data in the data structure, wherein the image data is based, at least in part, on scanning of the probe array.

18. The method of claim 17, further including the steps of:
(g) analyzing the image data to generate results data; and
(h) storing the results data in the data structure.

19. The method of claim 18, further including the step of:
(i) tracking the value, the image data, and the result data.

20. A method comprising the steps of:
(a) receiving from a first user a selection of a first data template having a plurality of identifiers each having one or more attributes;
(b) displaying the first data template to the first user in response to the selection;
(c) receiving from the first user values for one or more of the identifiers of the first data template in accordance with the attributes of the one or more identifiers; and
(d) saving the values in a data structure;
wherein the values are related to use of a probe array.

21. The method of claim 20, wherein:
the selection is made by selecting a name of the first data template from a list of names of a plurality of data templates.

22. The method of claim 21, wherein:
the plurality of data templates include one or more default data templates.

23. The method of claim 21, wherein:
the list of names is displayed to the first user in a tree structure of a graphical user interface.

24. The method of claim 20, wherein:
the data structure includes an experiment information file.

25. The method of claim 24, wherein:
the experiment information file is included in a database.

26. The method of claim 20, further comprising the step of:
(e) generating the first data template based, at least in part, on a second user specifying the plurality of identifiers.

27. The method of claim 26, further comprising the step of:
(f) generating the first data template based, at least in part, on a second user specifying the attributes of the plurality of identifiers.

28. The method of claim 27, wherein:
the first and second users are different users.

29. A computer program product, comprising:
(a) a template generator that generates a data template including one or more identifiers, each having one or more attributes;
(b) a value receiver that receives values for the identifiers in accordance with their attributes; and
(c) a data storage manager that stores the values in a data structure;
wherein the values are based on one or more experiments on one or more probe arrays.

30. The computer program product of claim 29, wherein:
the identifiers include experiment identifiers and the data template includes an experiment data template.

31. The computer program product of claim 29, wherein:
the identifiers include sample identifiers and the data template includes a sample data template.

32. The computer program product of claim 29, wherein:
the data structure includes an experiment information file.

33. The computer program product of claim 29, wherein:
the template generator generates the data template in response to a first user specifying at least one of the one or more identifiers.

34. The computer program product of claim 29, wherein:
the template generator generates the data template in response to a first user specifying at least one attribute of the one or more identifiers.

35. The computer program product of claim 33, wherein:
the data template is selected by a second user.

36. The computer program product of claim 29, wherein:
the data storage manager further stores instrument information regarding at least one instrument in the data structure, wherein the instrument is included in the one or more experiment.

37. The computer program product of claim 29, wherein:
the data storage manager further stores image data in the data structure,
wherein the image data is based, at least in part, on scanning of the one or more probe arrays.

38. The computer program product of claim 29, further including:
(d) an analysis application that analyzes the image data to generate results data; and
wherein the data storage manager further stores the results data in the data structure.

39. A computer implemented system for managing information of probe array experiments, comprising:
a computer-readable storage medium;
a database;
a data template generator coupled to the computer-readable storage medium; and
an experiment manager coupled to the computer-readable storage medium and the database,
wherein the data template generator generates at least one user-defined data template and stores the user-defined data template on the computer-readable storage medium, each user-defined data template defining attributes of a set of experiment identifiers, a data template being selected from the at least one user-defined data template by a user using the experiment manager, experiment identifiers being inputted using the experiment manager according to the selected data template, the inputted experiment identifiers being stored in the database as an experiment information file.

40. The system of claim 39, wherein:
instrument information is included in the experiment information file.

41. The system of claim 39, further comprising:
a data processor, coupled to the database, for acquiring experiment data and storing the experiment data as an experiment data file in the database;
a data analyzer, connected to the database, for analyzing the experiment data, generating analyzed result files, and storing the analyzed result files in the database; and
a file manager for tracking the experiment information file, the experiment data file, and the analyzed result files.

42. The system of claim 41, wherein:
the experiment data file is an image file.

43. The system of claim 41, wherein:
the file manager tracks the experiment information file, the experiment data file, and the analyzed result files according to file names.

44. A computer implemented system for managing information of probe array experiments, comprising:
a computer-readable storage medium having at least one default data table stored thereon;
a database;
a data template generator coupled to the computer-readable storage medium; and
an experiment manager coupled to the computer-readable storage medium and the database;
wherein the data template generator generates at least one user-defined data template and stores the user-defined data template on the computer-readable storage medium, each user-defined data template defining the attributes of a set of experiment identifiers, a data template being selected from the group consisting of the default data table and the user-defined data template by a user using the experiment manager, experiment identifiers being inputted using the experiment manager according to the selected data template, the inputted experiment identifiers being stored in the database as an experiment information file.
